(19) United States
(12) Patent Application Publication
(10) Pub. No.: US 2011/0161821 A1
(43) Pub. Date: Jun. 30, 2011

(54) Method, system and apparatus for managing and interacting with multimedia presentations

(76) Inventor: Louis Stewart, Holland, PA (US)

(21) Appl. No.: 12/459,172

(22) Filed: Jun. 26, 2009

(51) Int. Cl. G06F 3/01

(52) U.S. Cl. 715/731; 715/732; 715/840

(57) ABSTRACT

A method, system and device are provided for facilitating interacting with and management of a presentation involving one or more elements, such as, for example text, sound, pictures, graphics, video or combinations of these elements. The system, method and device provide a simple yet powerful and intuitive way for presenters to interact with and manage their presentations in multiple ways directly on an easy to see screen positioned in front of them using the icon based buttons positioned outside of the interactive display area. The system, method and device further are configured to provide interactive inputs which may become part of a presentation and saved.

### BACKGROUND OF THE INVENTION

1. Field of the Invention

The present invention relates to methods, systems and devices for interacting with and managing multimedia presentations.

2. Brief Description of the Related Art

Multimedia is widely used in a number of applications. In particular, multimedia applications are used to generate presentations. For example, a speaker may use multimedia applications with a presentation to an audience. The speaker may use slides with text, graphics, words, or combinations of these, and may even incorporate into the slides music and video clips. Often a laptop or notebook computer is used by an individual in order to present a multimedia application, such as, for example, a slide show.

It remains difficult for a speaker at times to interact with the presentation. A need exists for a method, system and device that will facilitate interaction with, presenting and management of multimedia presentations.

### SUMMARY OF THE INVENTION

A method, system and device are provided for facilitating management and interaction of a presentation involving one or more elements, such as, for example text, sound, pictures, video or combinations of these elements. According to preferred embodiments, a device is provided that includes a graphics display component with a plurality of navigation inputs. The method permits a user, such as, for example, a presenter, to interact with the presentation in multiple ways by utilizing the specially configured input mechanism provided in conjunction with the display component.

The method, according to preferred embodiments, provides the presenter with the ability to manage and interact with the presentation being displayed.

According to an alternate embodiment, the method is carried out so that a presenter may selectively choose to interact with the display component through direct inputs made by the presenter, or optionally may have the graphics display component linked with an auxiliary control component which may be operated remote from the display component so that someone other than the presenter, such as, an operator, may control some or all of the functions associated with the interactive display.

According to this alternate embodiment, the presenter may be afforded the ability to interact with an audience during a presentation by having the operator manage one or more commands to coordinate what is being displayed with the presentation and the presenter.

According to a preferred embodiment, a system is provided where a graphics display component is provided with a plurality of input features for managing and interacting with multimedia presentations, such as, for example, a slide presentation, and more particularly, a PowerPoint® presentation.

According to preferred embodiments, the system, method and device may be configured to control multiple input components, such as, for example a pen or interactive buttons, where a button may control an attribute or operation of another input component, such as a Highlighter. According to preferred embodiments, a button alternately, may operate a function of more than one input component when it is depressed or when released.

According to preferred embodiments, buttons of the device may be provided with a light enhanced feature so that where a presentation is given in a darkened room, for example, a presenter using the device may readily visualize and utilize the input components of the device. For example, one or more input components, such as input buttons, may be backlit, include LED's, an LCD screen, such as for example OLED and may further include the ability to load customized graphics on the button, in particular, when the button is configured as a type of screen. According to alternate embodiments, the button may comprise a touch panel where an image representing an icon is displayed as the button.

According to an alternate embodiment, the device may be configured with an interactive input that is provided separate from the screen display on which the interactive inputs appear.

According to preferred embodiments, a plurality of interactive input buttons may be provided outside of the display area on the display panel.

According to preferred embodiments, the device, system and method provide a mechanism for permitting interactive display elements to be generated and created by a user, such as a presenter, during a presentation, and the ability to save the slide with the changes or enhancements made by the user.

### BRIEF DESCRIPTION OF THE DRAWING FIGURES

The patent or application file contains at least one drawing executed in color. Copies of this patent or patent application publication with color drawing(s) will be provided by the Office upon request and payment of the necessary fee.

FIG. 1 is a front elevation view of a first embodiment of a presentation management and interactive device according to my invention.

FIG. 1a is s perspective view of an example of an input device comprising a pen.

FIG. 1b is an enlarged view of the input buttons, shown separately from the screen display of the device.

FIG. 2 is an illustration of the device of FIG. 1 shown in an environment connected with a computer and with the device output being communicated to a video presentation screen and/or video switcher.

FIGS. 3 through 18 illustrate examples of screen display screens displaying slides of an exemplary PowerPoint® presentation and controls.

FIG. 19 shows an example of a presentation management device in an environment shown with a computer, and with a remote operating component.

FIG. 20 is an example of an alternate embodiment of a presentation management and interactive device shown with the input mechanism provided in a positionable location relative to the graphics display panel of the device.

FIG. 21 is an example of another alternate embodiment of a presentation management device showing an input mechanism including a pen and a button bar provided in a positionable location relative to a touch screen display of a tablet computer.

### DETAILED DESCRIPTION OF THE PREFERRED EMBODIMENTS

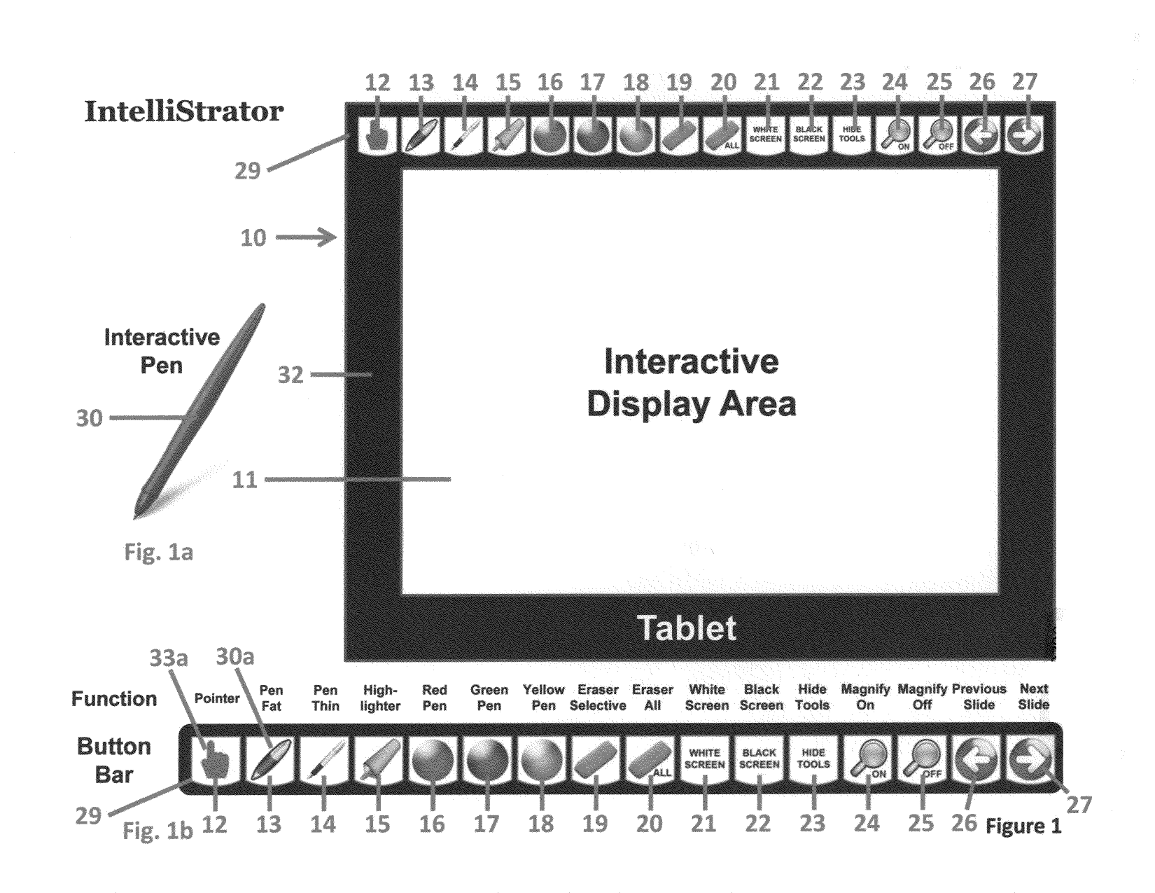

FIG. 1 is an illustration of a preferred embodiment of a presentation management and interactive device 10 according to my invention. The device 10 includes an interactive display area 11 and includes an input component shown comprising a plurality of input buttons 12-27. An interactive input element, such as, for example the pen 30 (FIG. 1a), further facilitates interaction with the presentation by having the pen 30 control functions on the interactive display area based on the location at which the pen 30 is positioned, touched, or otherwise moved. The interactive pen 30 preferably has a tip configured to interact with the interactive display area 11 to produce a response from the sensing of the pen tip (and its movement) by the display area 11.

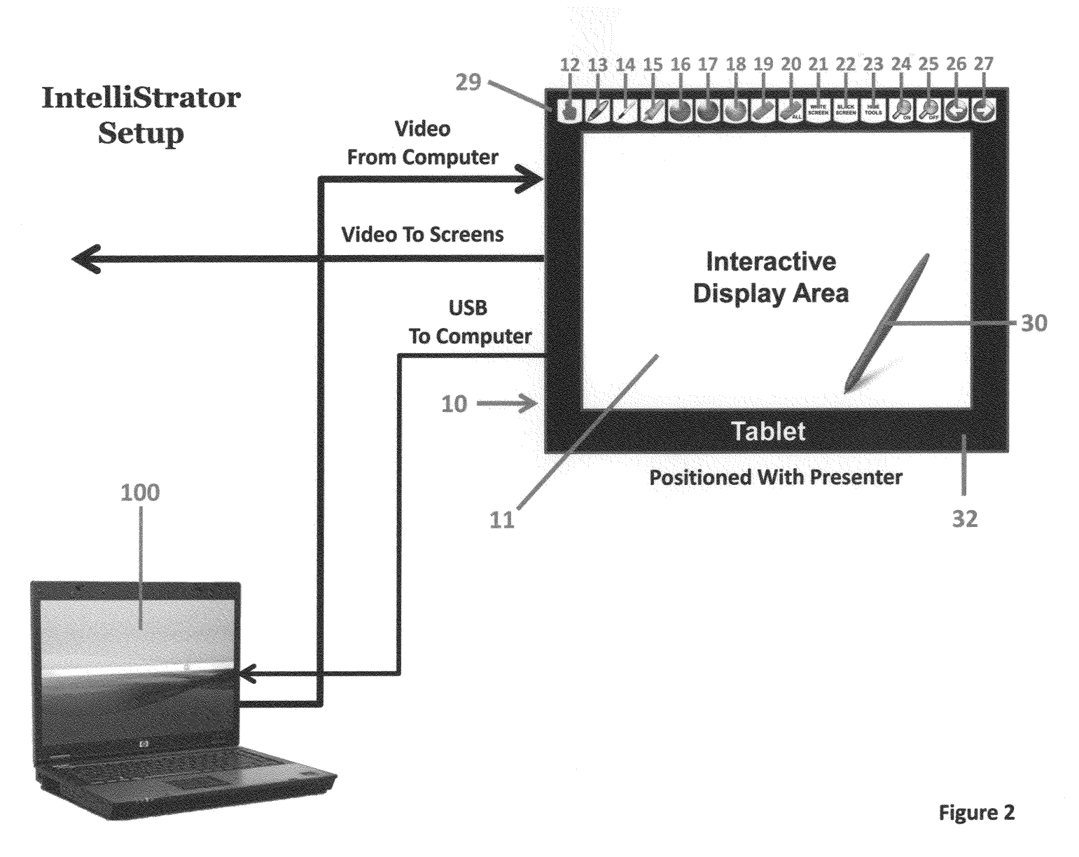

The device 10 preferably comprises an interactive display area 11, which may be configured as a screen, such as, for example, an LCD or other screen that is in communication with one or more processors. The display area 11 may be constructed from a commercially available touch screen type display that is programmed to send the touching and movement of an object such as the pen 30 on the surface of the interactive display area 11. For example, according to a preferred embodiment, the device 10 may be linked with a computer 100 as shown in FIG. 2. The computer 100 preferably includes a processor and also preferably includes memory and includes or may be linked to a storage medium, such as, for example, a hard drive or other disk drive. Preferably, the computer 100 has an operating system installed and/or loaded in the memory. According to a preferred embodiment, the operating system is one that may be used to run a presentation program, such as for example, a Windows® based operating system (e.g., Windows XP or Vista). The presentation program may be implemented through the computer 100, and preferably may comprise the MicroSoft® PowerPoint® presentation program that can be used to create slides.

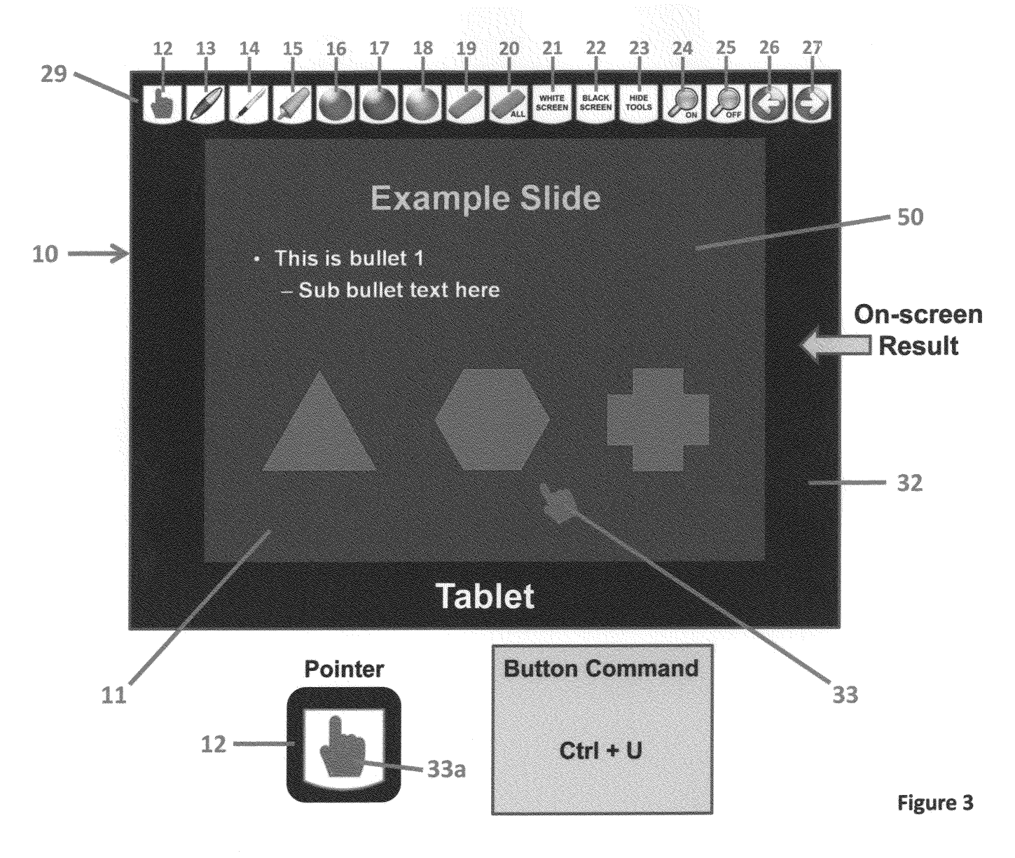

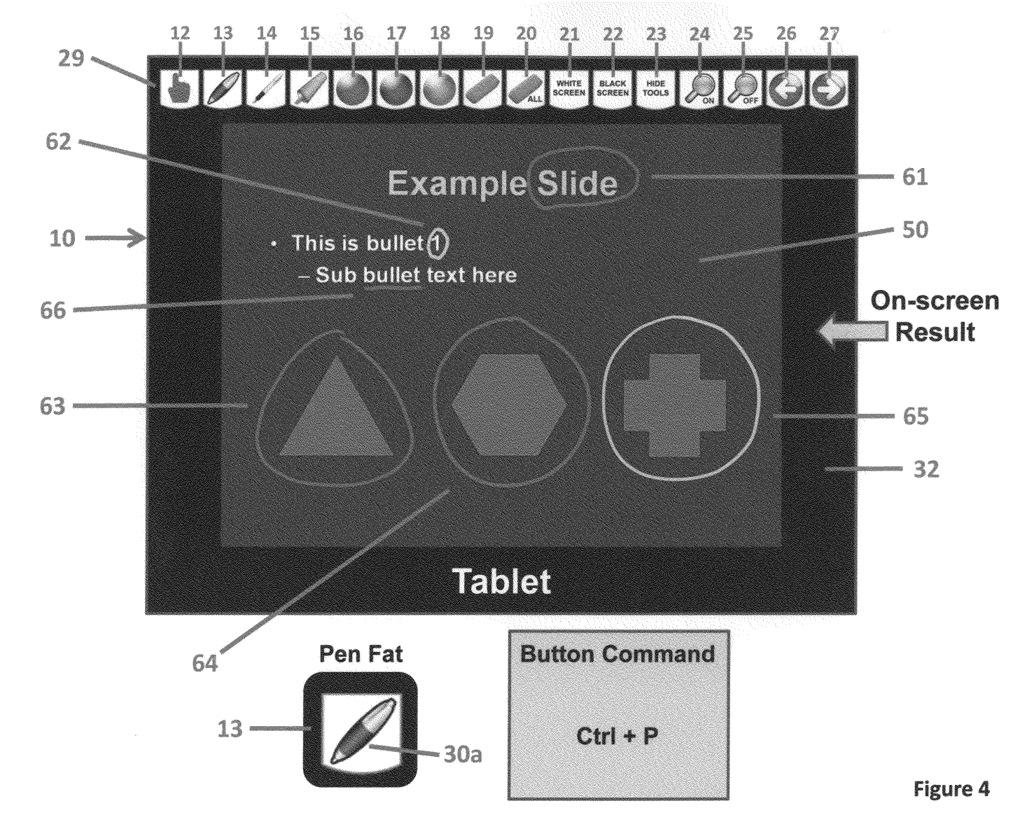

The device 10 preferably includes a display that is a tablet type interactive display with a screen display area 11 that is capable of responding to a stimulus provided at the surface of the screen display area 11. The screen technologies that may be implemented in the device to provide the interaction display area 11 include those screens which provide a touch area that are configured to respond and identify the position of a screen that was touched. These screen panels are commercially available. Software may be implemented to regulate the detection and coordination of the location of an implement on the touch screen such as the pen 30 on the display area 11. The software that is configured to recognize the locations receiving a response or engagement from pen 30 on the touch screen may be configured to supply an output to a software program that, when actuated, such as for example by one of the buttons 12-27, may provide a response on the screen display area 11 conforming to the positioning and movement of the pen 30. According to a preferred embodiment, the stimulus to which the screen is programmed to respond to may be from a finger or implement, such as for example, the pen 30. According to preferred embodiments, the device 10 may be configured so that the pen 30 may be used to provide interactive responses. According to one embodiment, the pen 30 may be used to make indicia appear on the display area 11. Indicia, for example, may comprise writing that the user of the pen 30 desires to place on the interactive presentation, such as, for example a slide that the user is displaying. An example of a slide 50 is shown in FIG. 3 and is illustrated in FIGS. 4 through 18 with interactive features implemented and applied to the slide 50. The indicia may include writing or other marking that may generally be made with or brought about with the use of the pen 30. The indicia as well as other indicia may be manipulated or managed with one of more of the interactive input buttons 12 through 27.

Referring to FIGS. 3 through 14, examples of screen display images that may be generated and interactively managed with the presentation system and device 10 are shown. The screen display images generally may be comprised of a slide image and enhancements made by the user or operator of the device 10. According to a preferred embodiment, an implement for producing a desired indicia or image on the interactive display screen area 11 preferably may comprise the pen 30. The screen display images of FIGS. 3 through 18 are examples of a presentation. FIGS. 3 through 11 and 14-18 include slides 50, 51, 52 prepared with the PowerPoint® software presentation program. The slides 50, 51, 52 of the PowerPoint® presentation program may be manipulated during the presentation to provide enhanced interactive presentation features. A presenter may take advantage of the features provided by the present system and device 10.

Referring to FIG. 3, there is illustrated an example slide 50 with exemplary text and graphic images (e.g., a triangle, hexagon and cross). The interactive display area 11 of the device 10 preferably may have a border zone 32 which surrounds the display area 11. The display area 11 within the perimeter of the border zone 32 preferably comprises the interactive response area that is responsive to the input implement, such as for example the pen 30. Preferably, the input buttons 12-27 are arranged in the border zone 32 of the device 10 to minimize interference with the interactive display screen area 11. According to preferred embodiments, the device 10 is constructed so that the user may view the entire interactive display area 11, which shows the user the same display image as the display output image that is communicated to the video display screen that is to be viewed by an audience. For example, the device 10 may be utilized and preferably is viewed by the user or presenter while other video display screens such as a larger display or a plurality of large displays in a room are linked with the output of the device 10 directly, or through a computer or other communication or transmission device so that the audience may view the same slide with the same notations as the user of the device. According to preferred embodiments of the video display output image from device 10 is linked with a video connection, such as, for example, a VGA connection or wireless or other suitable connection to transmit the video image. A cursor graphic 33 is illustrated on the interactive display area 11 to show the location of the pen 30 relative to the display area 11. Preferably, the system and device 10 are configured with software that controls the display area 11 and the cursor graphic 33 displayed thereon. The cursor graphic 33 is illustrated as a hand, but may comprise a number of desired images, including images which the user may select. The software that controls the cursor graphic 33 provides instructions for displaying the cursor graphic 33 relative to the location of the pen 30 on the screen display 11, so that the cursor graphic 33 location may correspond with the location and movement of the pen 30. Preferably, the touch screen technology implemented in the display area 11 relays the location of the pen 30 to the processor through software implemented to operate the touch screen panel such as the display area 11. An interactive input panel, such as the button bar 29, shown separately in FIG. 1b, is provided with a plurality of control selections that are preferably identified by representative indicia. Button features and/or configurations are provided to facilitate the interacting by the presenter with the presentation and audience. According to a preferred embodiment, one configuration for the navigation buttons 12 through 27 of the button bar 29 is backlit icons. Because in many instances presentations are given from a stage or in a darkened room where the lighting is not optimal, the use of the backlit buttons facilitates the navigation of the tools. According to an alternate embodiment, the buttons 12 through 27 may be configured as an OLED display (or displays) which provides basically a small screen on the face of the button. The small screen may be sent an image (icon). Furthermore, another feature that may be provided is that the OLED button screen may include an icon that is configured to be touch sensitive, instead of depressing a “button”. The touch sensitive icons may be configured on a single OLED panel that represents the button bar 29 and a plurality of buttons on the panel. Preferably, as with the alternate embodiments described herein, according to preferred configurations, the button bar 29 remains outside of the screen display area 11, so the user may view the same image as the audience.

For example, considering the cursor graphic 33, the hand image 33a may be provided to appear on the button 12. Similarly, the other buttons shown, for example buttons 13 through 27, may be provided with an image corresponding to the feature that they represent. Preferably, the device 10 is configured so that the pointer button 12 may be depressed to actuate a condition that when depressed turns on the cursor graphic 33 so that it is displayed on the screen display 11. The cursor graphic button 12 preferably controls the pointer feature by turning on the cursor graphic 33 appearing on the screen display 11, (so it is displayed). When the cursor graphic button 12 is actuated (e.g., depressed), the cursor graphic 33 on the screen display area 11 appears. The pen 30 preferably is used to direct the pointer or cursor graphic 33 to a location or locations, or movement thereof, on the display screen 11. The cursor graphic 33 may be made to disappear from the screen display area 11 by pressing the “hide tools” button 23 which deactivates the input component such as pen 30. Therefore the pen may be used as a pointer when the button 12 is depressed and the cursor graphic 33 may be moved about the display area 11. The input component, such as the pen 30, may be configured to operate in conjunction with one or more additional interactive input buttons, such as the selection buttons 13 and 14, which may facilitate a usual presenter interacting with the slide presentation by changing the cursor graphic 33 to an interactive writing instrument that will enable the user to utilize the pen 30 to draw or write text. Again, the hide tools button 23 may be utilized to deactivate the writing features such as the buttons 13 and 14.

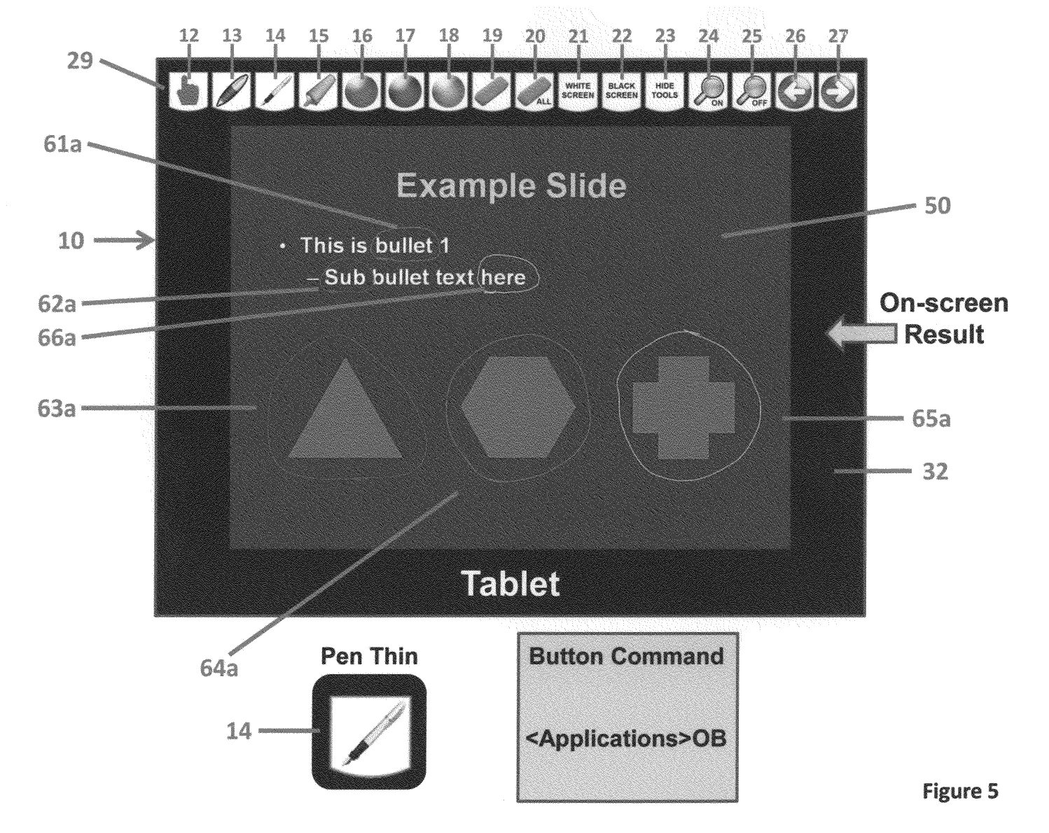

The exemplary slide 50 is illustrated in FIG. 3 appearing on the display screen 11 shows three shapes, with the cursor graphic 33 pointing to the hexagon shape. The slide 50 may be part of a PowerPoint® presentation, and may be created with the software program PowerPoint® (MicroSoft®). The pen 30 may be actuated with the pen graphic button 13 which shows the pen graphic 30a corresponding to the pen 30. The pen 30 may be used to interact with the presentation or slides being displayed by allowing the user to add to the presentation with contemporaneous markings, such as, for example the circles 61, 62, 63, 64, 65 and the underlining 66 shown in FIG. 4 and the thin pen circles 61a, 62a, 63a, 64a, 65a and 66a shown in FIG. 5. Other possible input methods include placing text on the screen display 11 while the slide 50 is being displayed.

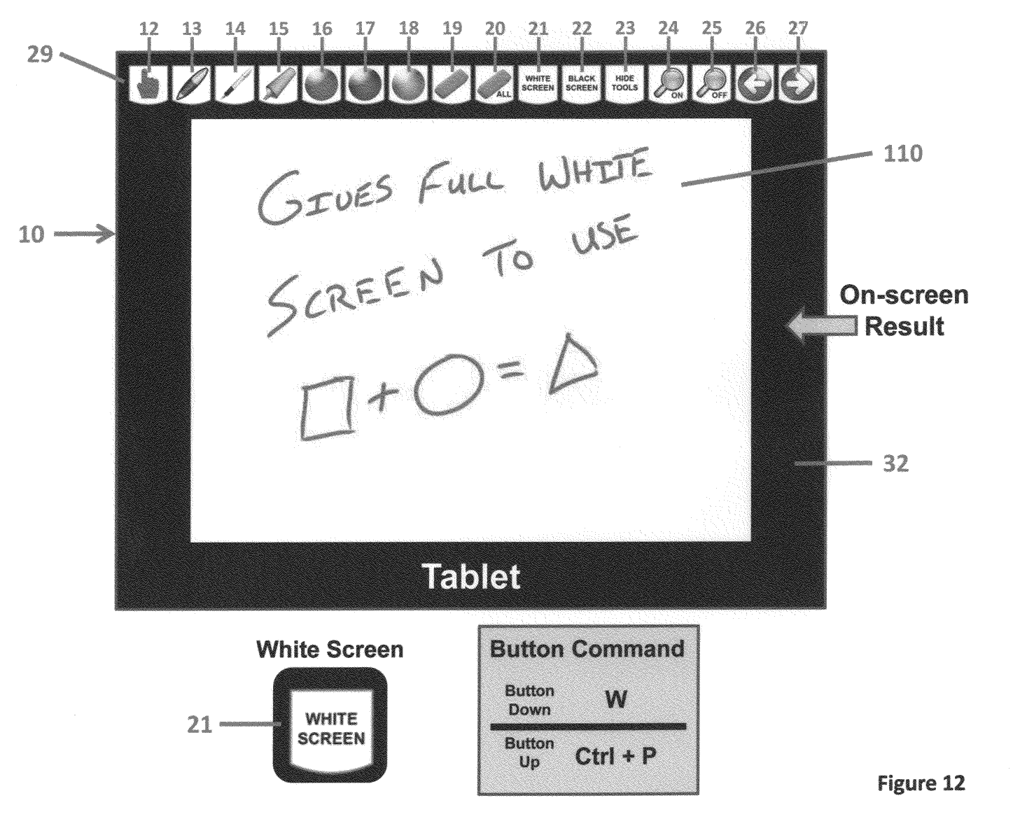

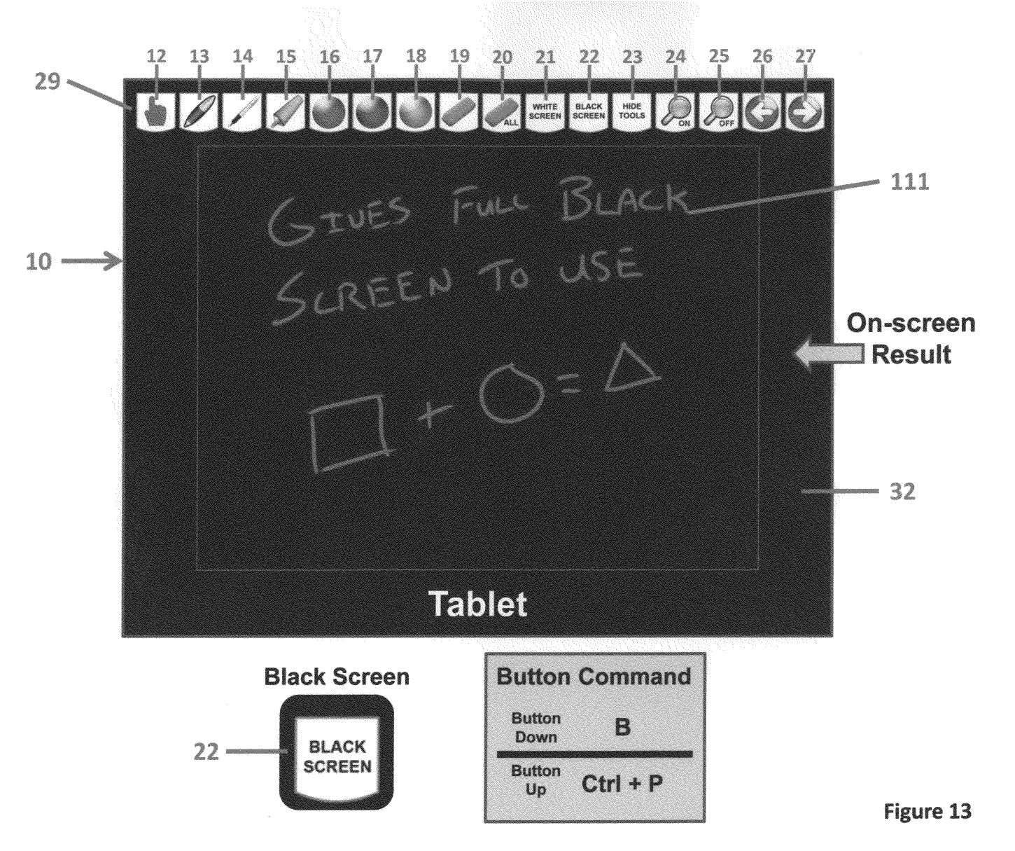

For example, referring to FIGS. 12 and 13, the screen display may be converted to a white board 110 (FIG. 12) or black board 111 (FIG. 13). An actuator, such as, the “white screen” actuation button 21, may be configured to display a white board 110 on the display screen 11 when the “white screen” button 21 is depressed and the pen 30 is activated when the button is released. Similarly, the black board 111 may be displayed by depressing the “black screen” button 22. The pen 30 may be used to create a slide contemporaneously during a presentation. Where a presentation has been previously prepared, the user may invoke the white screen or black board display inputs and generate an image with the input device, such as the pen 30. However, the system and device 10 provide a capture feature which may capture and save the user input, such as, for example, the information on the display 11 shown in FIGS. 12 and 13. The information may be saved as a slide and may be saved in the order of the presentation in which it was presented (e.g., after the fifth slide, for example).

The pen 30 may be adjusted for a selection preference attributes, including, for example, line thickness as well as color of the line or pen output. FIGS. 4 and 5 illustrate differences in colors that may be obtained using the pen 30. The lines illustrated in FIG. 5 show a thin pen line, whereas a second line thickness, illustrating a relatively thicker line, is shown in FIG. 4. Pen selection buttons 13 and 14 are shown and provide a user to select between one or more pen renditions that appear on the display screen 11 when the pen is activated. The pen selection buttons 13, 14, are preferably configured so that the pen 30 is activated for use when the button 13 or 14 is depressed. The user also may switch between pen line thicknesses by depressing the other one of the pen buttons 13, or 14 when the pen 30 is in use. Depressing the “hide tools” button may be used to deactivate the pen 30 to turn off the pen feature so that if a user moves the pen 30 across the display area 11 (e.g., even accidentally) no additional writing will occur as a result thereof.

The pen 30 is configured to interact with the display area 11 to provide the user with the ability to change the appearance of the pen writing, as well as the color that the pen writes on the interactive display 11. One or more color features may be provided, such as, for example, the color selection buttons 16, 17, 18. The color selection buttons 16, 17, 18 preferably have a color graphic 16a, 17a, 18a, that corresponds to the color that appears when the button is selected. The pen 30 therefore may be used to display a line of a selected color.

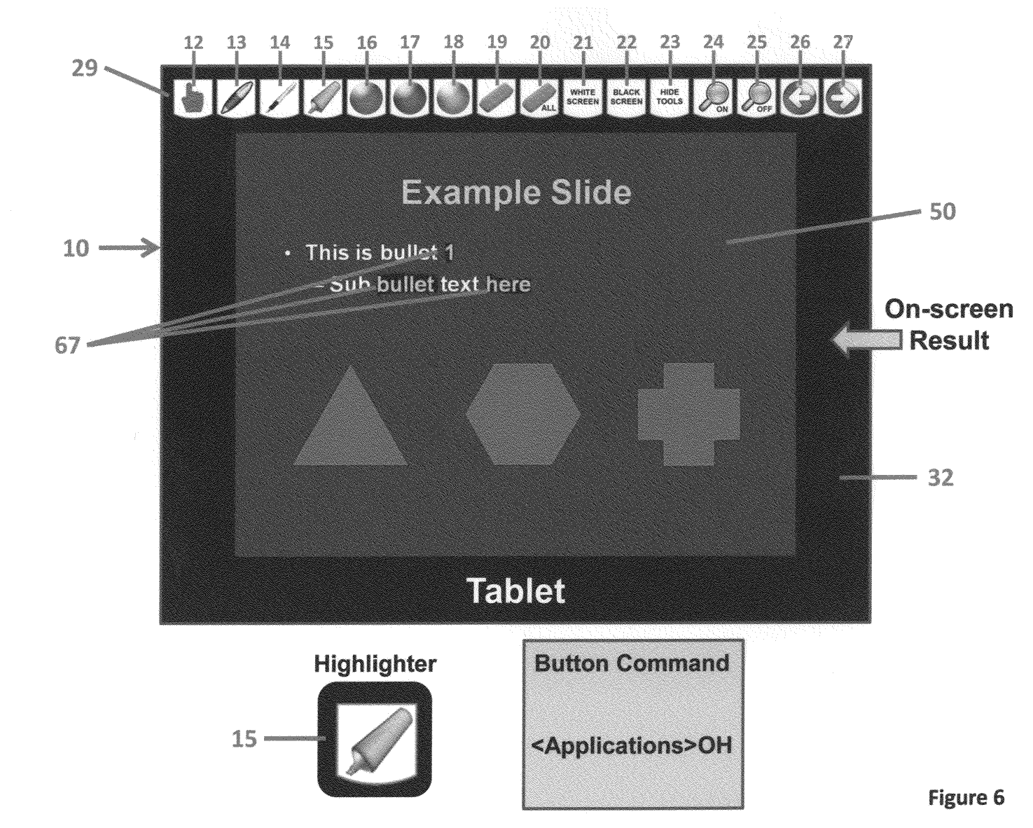

The device 10 also may be configured with a highlighting tool, which may be activated to provide highlighting of the display screen 11 in areas where the pen 30 is moved across. For example, the pen 30 may be used to highlight text or other graphics appearing on the slide 50. The highlighter button 15 may be activated by depressing it. The pen 30 therefore functions as a highlighter when the highlighter button is depressed. FIG. 6 shows an example of the highlighter button and the slide 50 where the image text 67 has been highlighted. The highlighted slide 50 may be saved for future use and reference. The highlighter feature of the device 10 may be utilized contemporaneously with the presentation of the slides of a slide presentation, such as a PowerPoint® presentation.

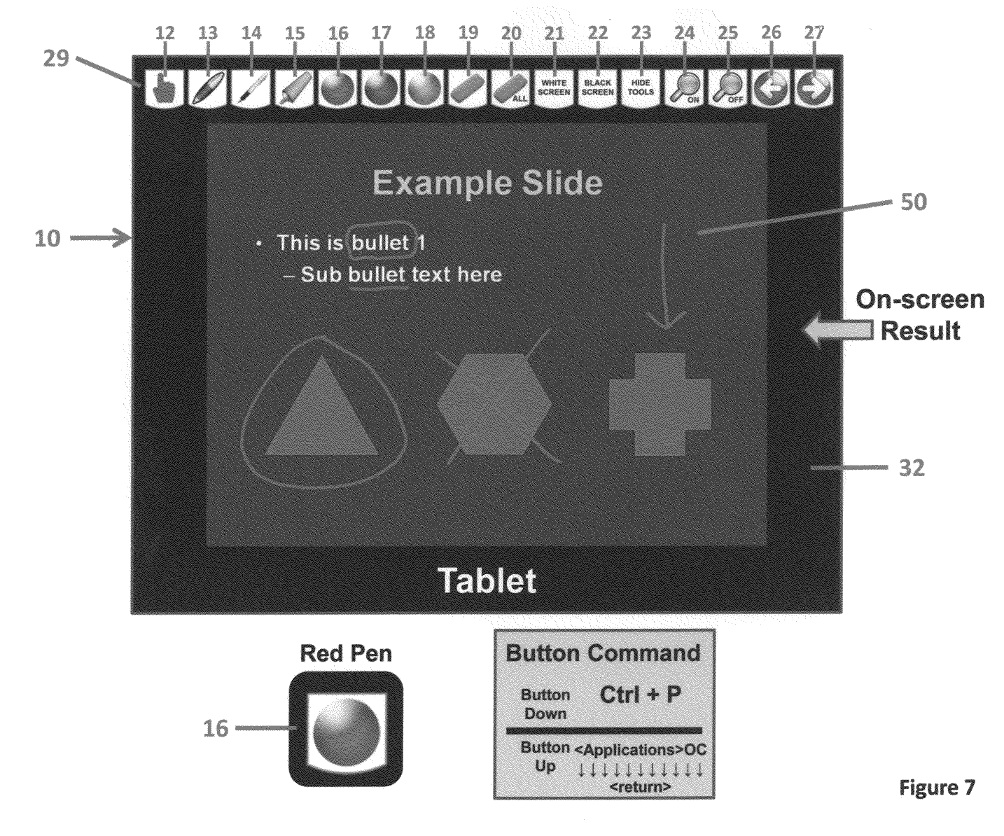

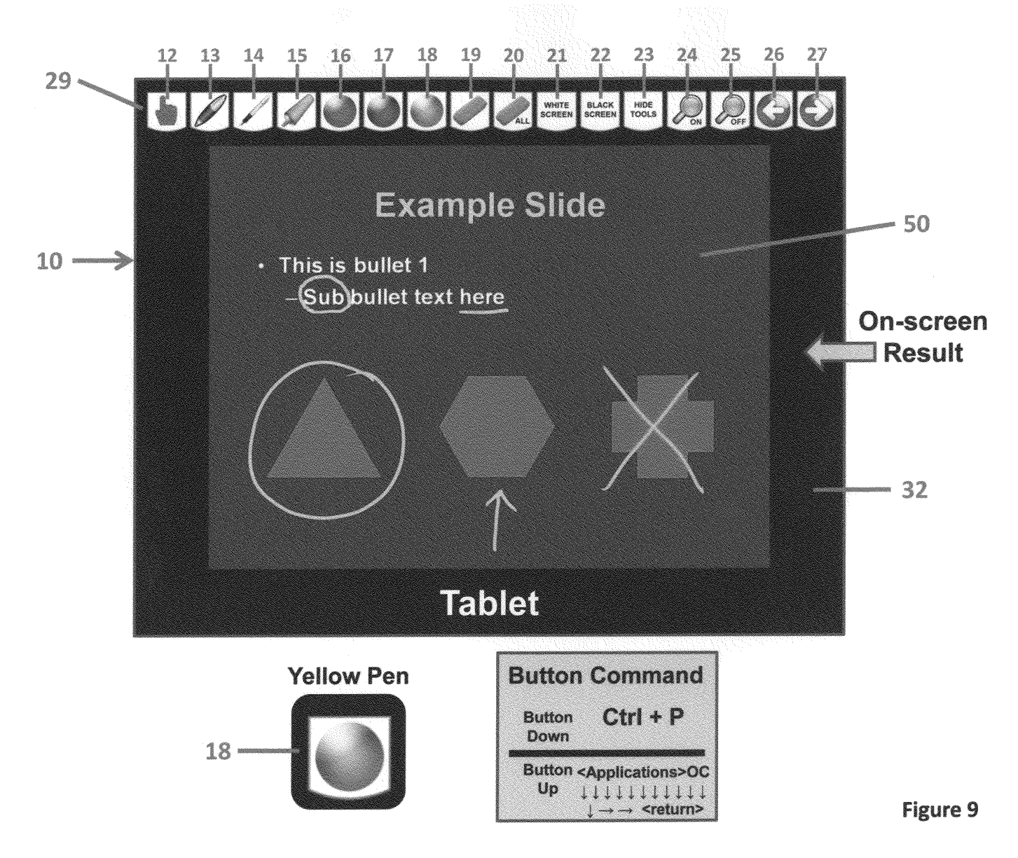

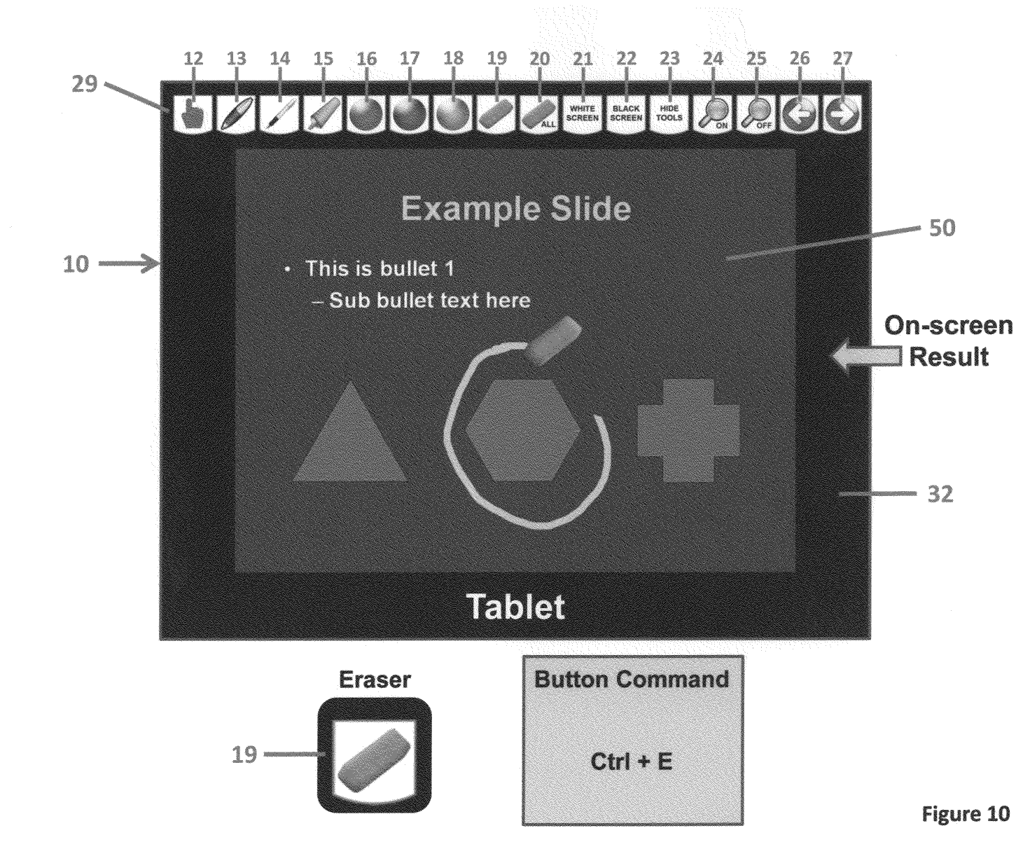

FIG. 7 illustrates an example of the slide 50 wherein a red pen button 16 has been selected to have the pen 30 write red on the display surface 11. Similarly, the green pen button 17 and yellow pen button 18 are illustrated respectively in FIGS. 9 and 10, to show the pen color change.

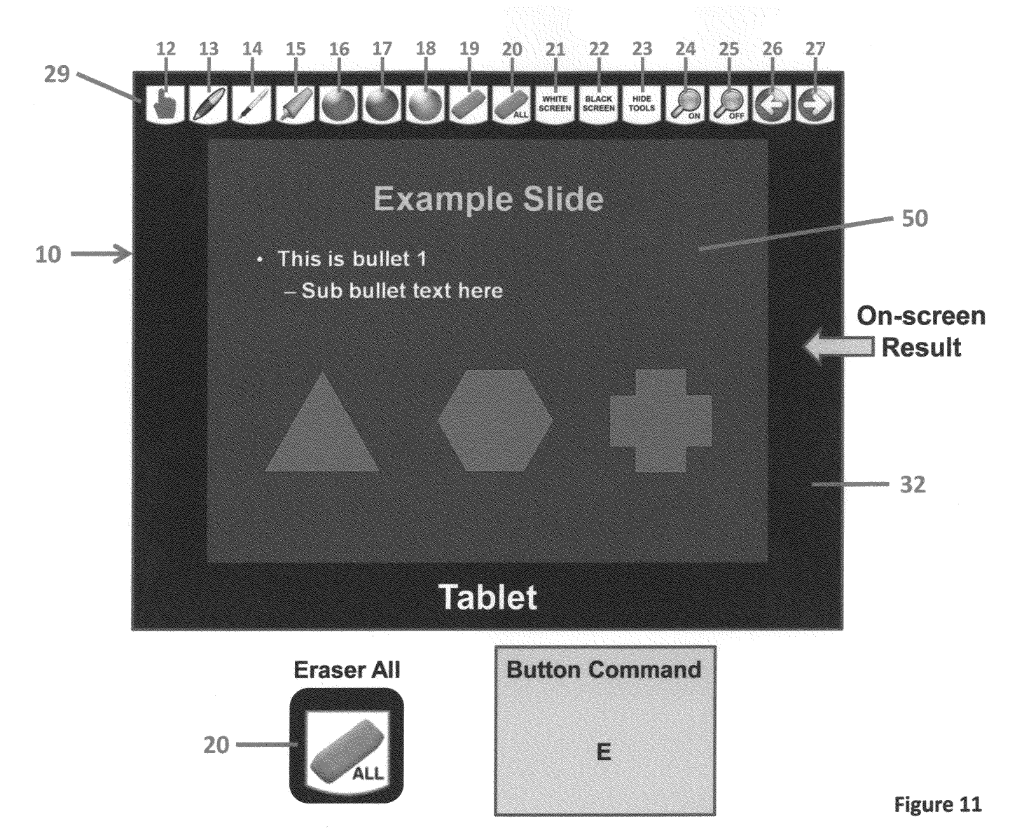

FIG. 10 illustrates the system and device 10 including the feature of an eraser. The pen 30 may be used to erase text or other images that was drawn with the pen 30. The first eraser button 19 corresponds to a selective eraser and may be depressed to actuate it so that the pen 30, when moved across the display surface area 11 (when the feature is actuated), functions to selectively erase previously drawn indicia over which the pen 30 is moved. An alternate eraser button 20, named an “erase all” button, as shown in FIG. 11, may be depressed to remove the all of the previously drawn indicia. FIG. 11 shows the display 11 with the writing removed (compare with the slide of FIG. 9 for example). The erase all button 20 is provided as a convenient way to return to a slide without the markings on it. This is done with the actuation of a single button, e.g., “erase all” button 20 so that the user may write and erase material on the interactive display 11 during the slide presentation, and may do so over the slide 50, or as discussed herein, on the white board or black board features that may be initialized through the device 10 and system. (See FIGS. 12 and 13)

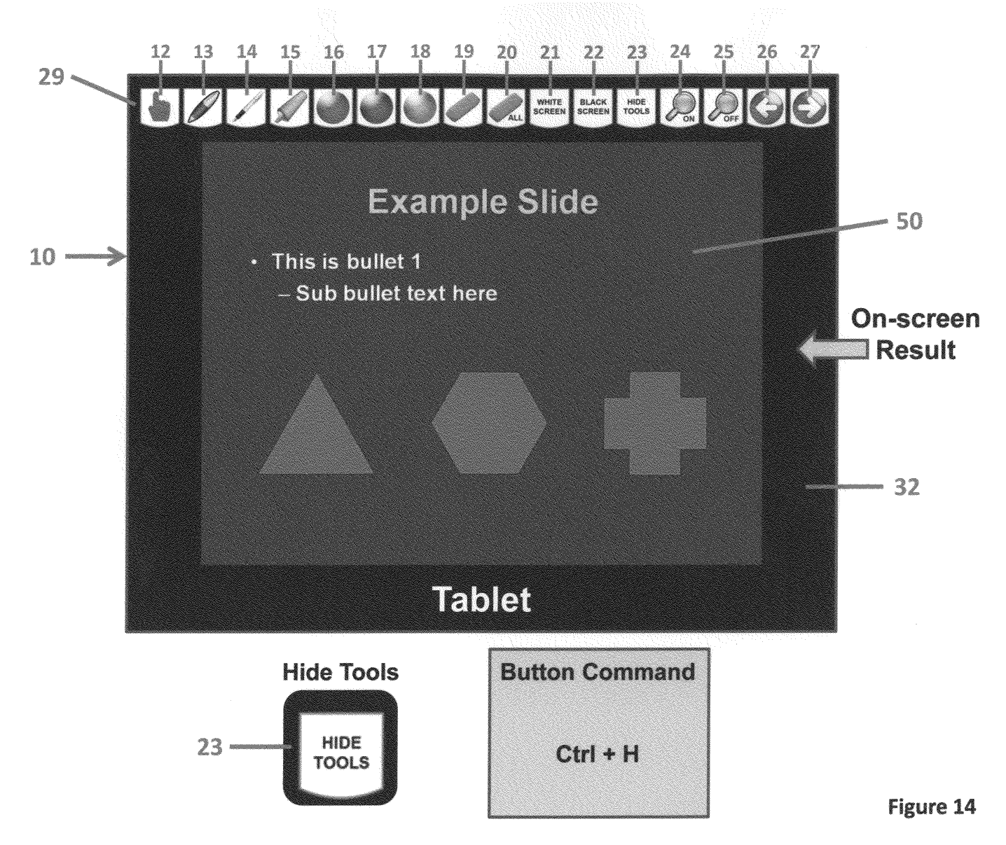

A hide tools feature preferably also is provided. The device 10, as shown in FIG. 14, includes a hide tools button 23 as part of the input selection options. The “hide tools” feature, when activated, permits the user to remove any tool icons from the screen, however the enhancement that the user has made on a particular slide will remain. The “hide tools” button 23 may be utilized so that the tools may be deactivated so as not to interfere with the readability of the slide. An example of a use for this feature would be when the presenter has used the highlighter tool to make some annotations on the screen and has finished, the rectangular tool icon does not disappear from the screen and could be distracting to the audience. The hide tools button 23 will deselect the highlighting tool and therefore hide the icon.

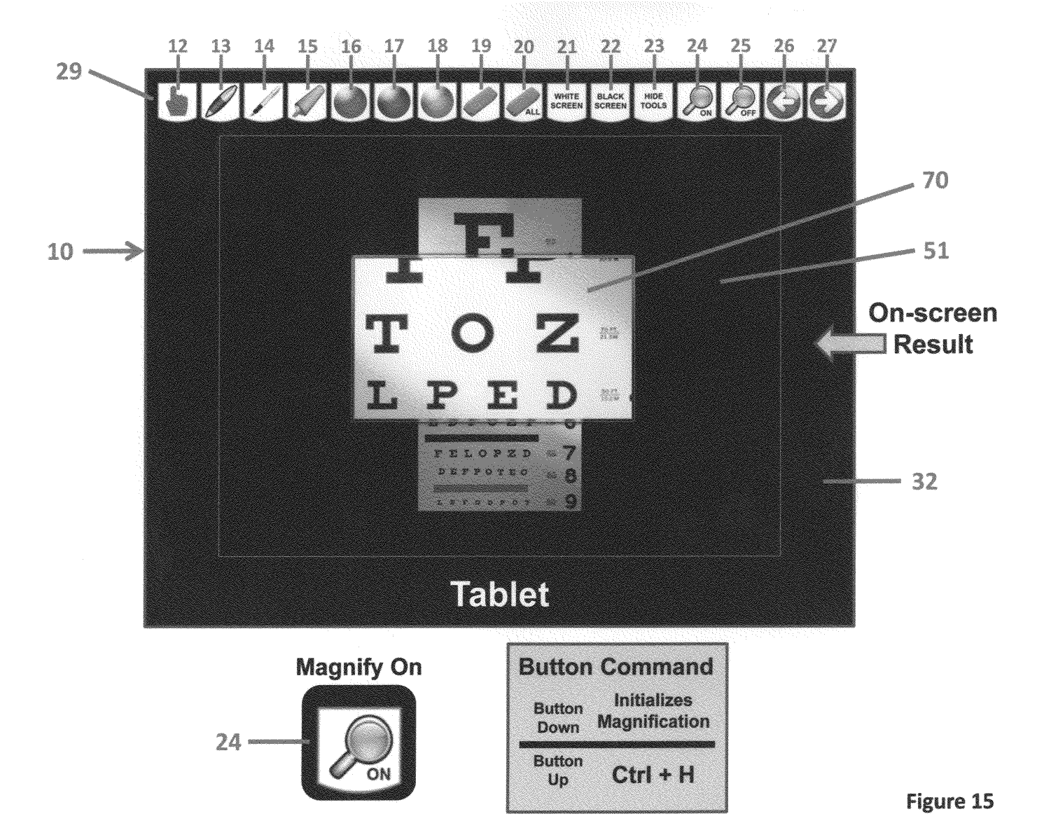

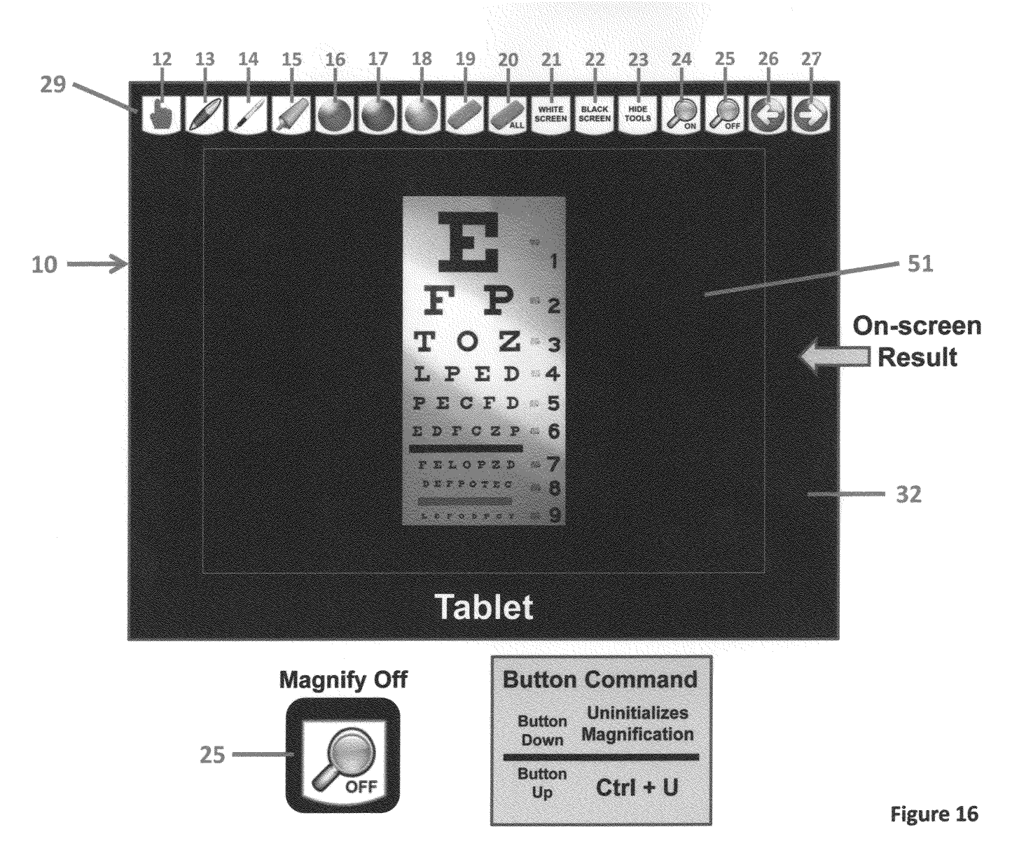

The system and device 10 further includes a selection magnification tool. The selection magnification tool facilitates accentuating a selected area of a slide. The selection may be done contemporaneously during a presentation by the user. The magnification button 24 may be selected to provide magnification of an area of the display screen 11. For example, according to a preferred embodiment, a window 70 containing the magnified area of a portion of the screen display 11 is shown in FIG. 15. Preferably, the device 10 and system are configured so that the window 70 may be moved using the pen 30, and may be allowed to be positioned and repositioned at locations on the screen display 11 as desired by the user. The magnification feature may be deactivated by depressing the “magnify off” button 25, as shown in FIG. 16 to return to the screen display 11 and remove the window 70 (previously appearing on FIG. 15). Note on functions of the magnification buttons. When magnify on is depressed it selects the magnification tool and when it is released it initiates “hide tools”. This is important for example if the presenter was using the pen and then selected magnify if hide tools was not initiated when they moved the magnification area around the screen they would be also drawing a line. After initiation of magnify any of the tools may be selected and used in conjunction with magnify if the presenter so wishes. When magnify off is depressed it turns off magnify and when the button is released it selects the pointer (it could also select another tool depending on preference) so the presenter can continue their interactions.

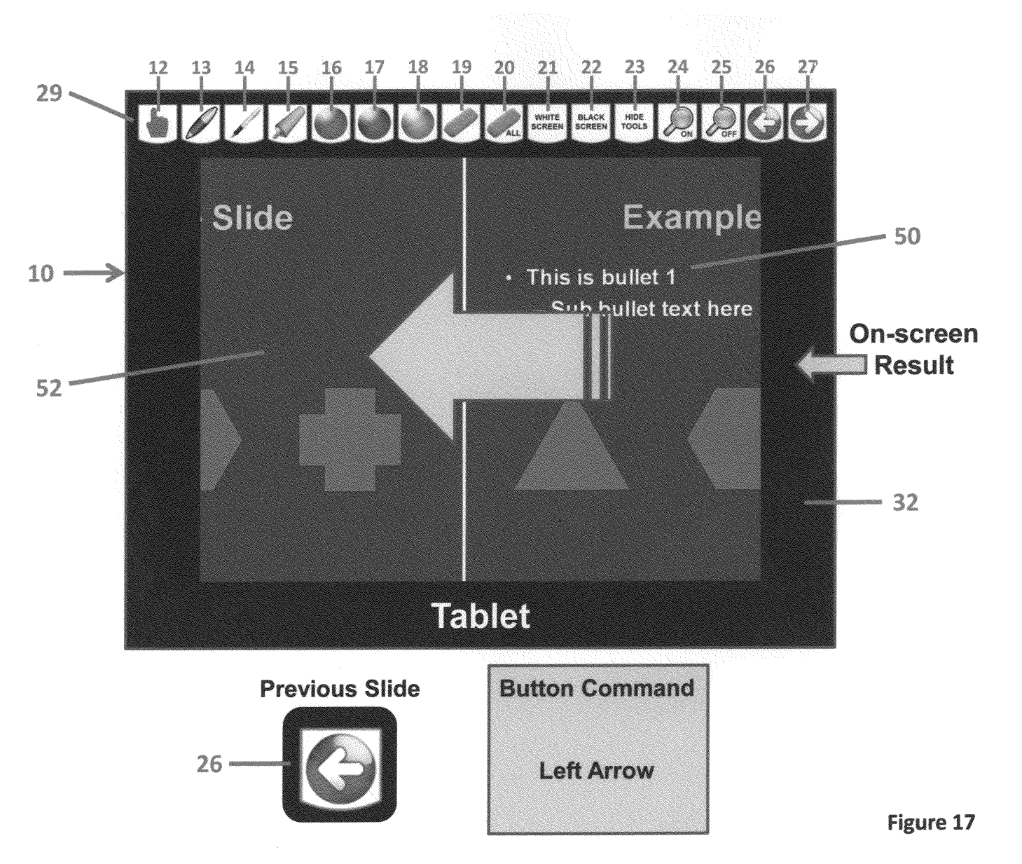

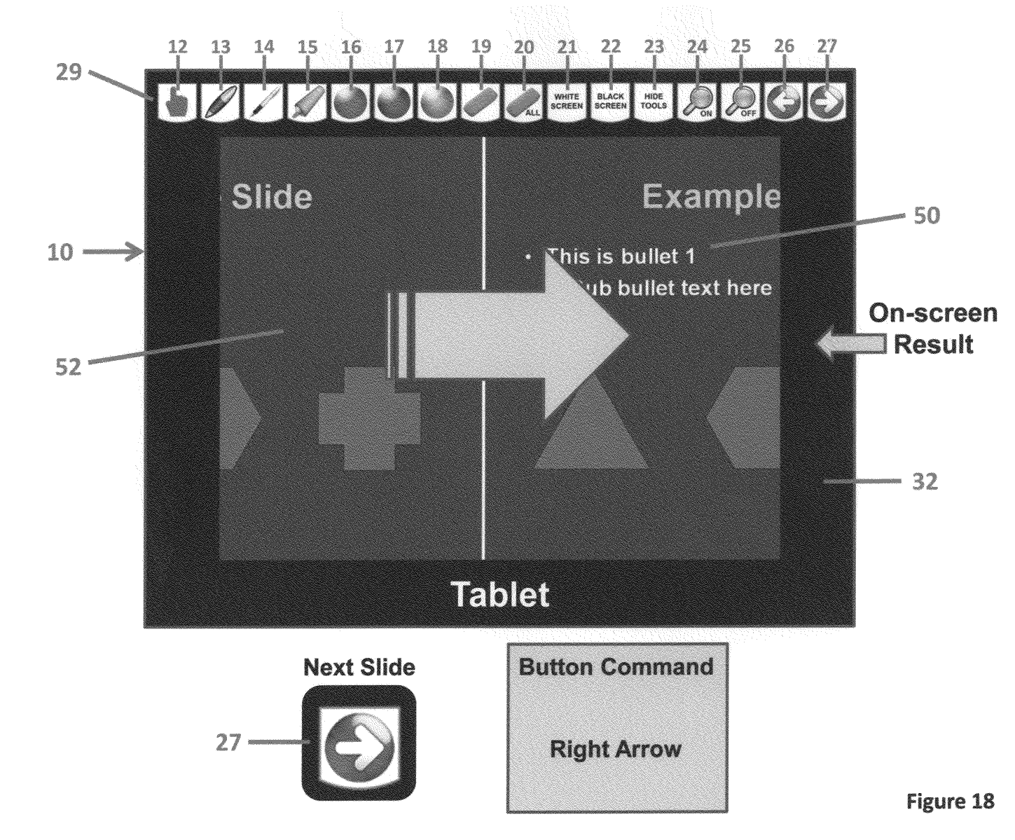

The system and device 10 also afford the user the ability to manage the slide presentation by depressing selection input buttons to advance the slides or to return to a previous slide. The “next slide” button 27 and “previous slide” button 26 are shown in FIGS. 17 and 18 respectively. Again, as with the other features, the user may utilize the input tool buttons on the device 10 to manage the slide presentation and interact with the audience.

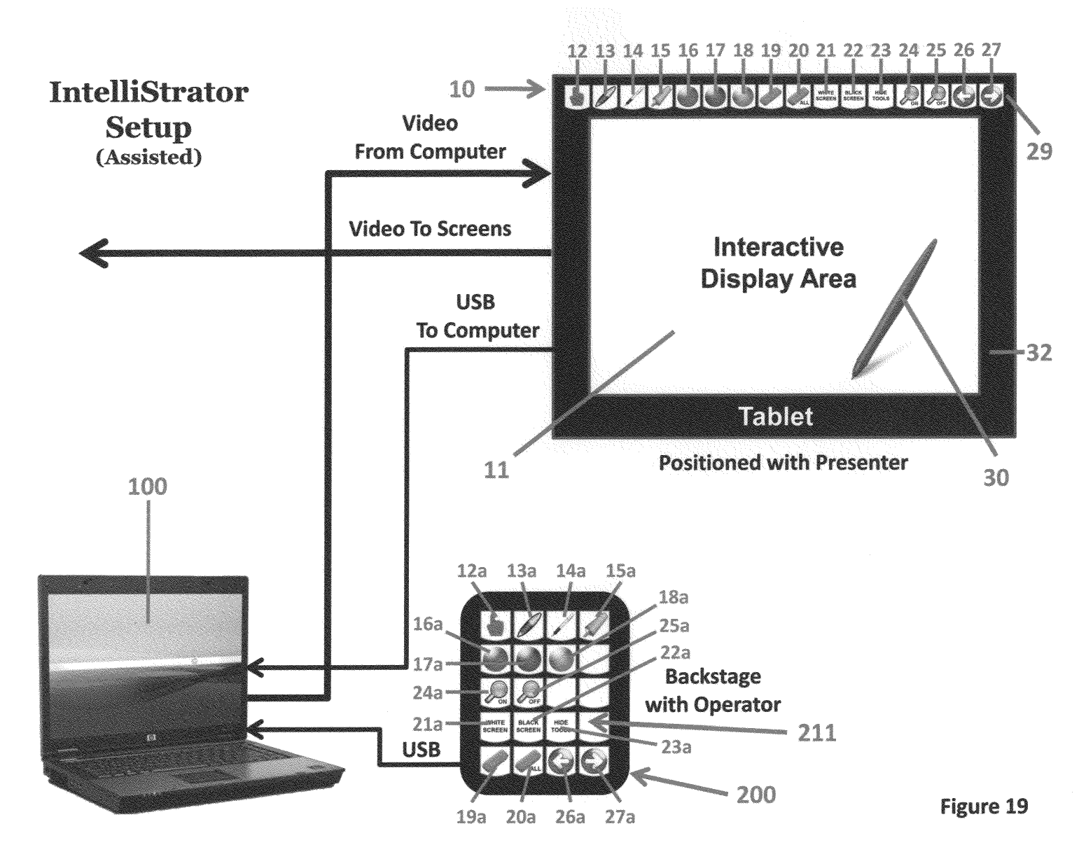

According to an alternate embodiment, the system and device 10 may be utilized with a secondary operation input. A secondary input controller 200 is shown in FIG. 19. The secondary input controller preferably has input selection buttons, and preferably includes the selection buttons that correspond with those 12-27 of the device 10. According to alternate embodiments, the controller 200 may have one or more additional input buttons. In the embodiment illustrated in FIG. 19, the secondary controller 200 includes the buttons 12a through 27a that correspond with the buttons 12 through 27 that are provided on the device 10.

The system may be utilized to permit an operator to be in a location remote from the presenter and control the presentation along with the presenter, if that is desired. Another option is to have the remote operator control certain functions while the presenter controls other functions. For example, the remote operator may advance slides while the presenter is moving about, or the remote operator may be instructed by the presenter to perform certain functions, like to enlarge an area of the slide.

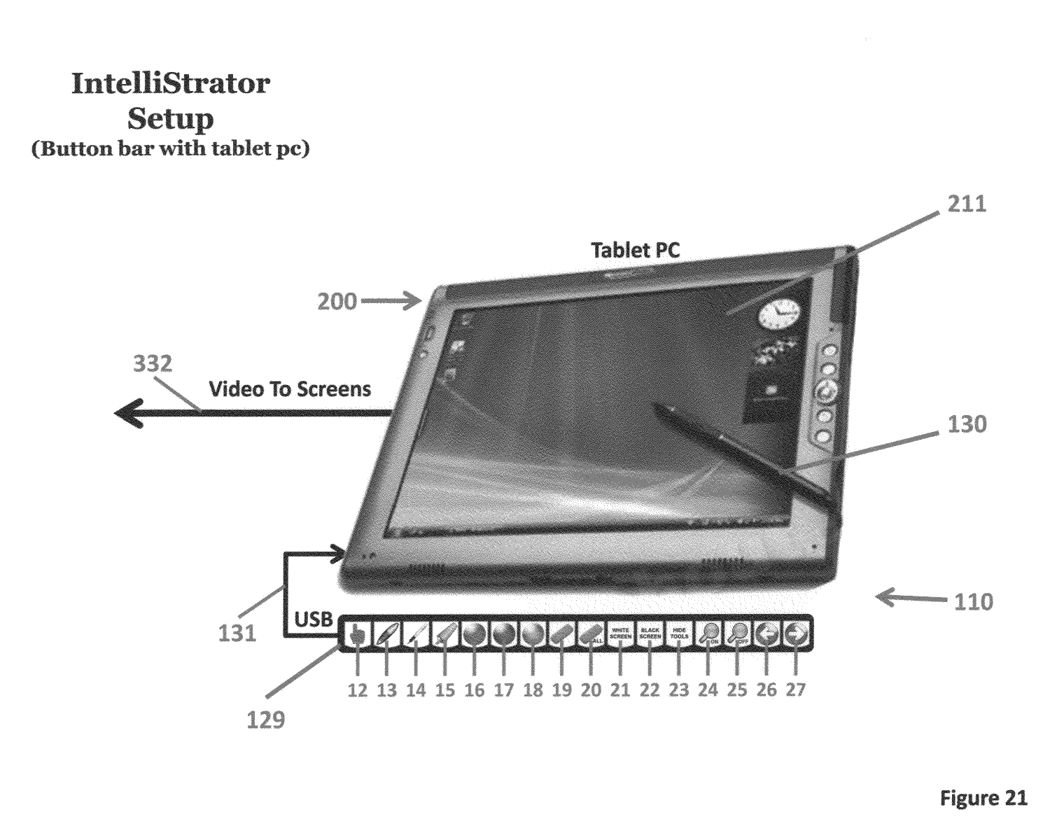

Another alternate embodiment is illustrated in FIG. 21, where an example of a presentation management device 110 showing an input mechanism including a pen 130 and a button bar 129 provided in a positionable location relative to a touch screen display of a tablet computer 200. Software may be provided to manage the operations of the button bar 129 and features thereon so that the pen 130 and other features may be utilized as discussed to facilitate interacting and managing a slide presentation. The button bar 129 may be configured with the features described herein in connection with embodiments of the invention. The button bar 129 is illustrated having the functions of the button bar 29 shown in FIGS. 1-19. A link, such as, the USB connection 131 is shown to link the input component, the button bar 129, with the tablet computer 200. The tablet computer 200 includes a screen display 211. The tablet computer 200 also is shown having an output 132, which may, for example, comprise a video cable that may connect to one or more video screens for viewing of the presentation by an audience. The output 132 may be communicated to a device, such as, for example, a video switcher (not shown), to further facilitate display of the presentation to one or more video screens. Alternately, the video output may be connected with a video switcher that may be used to control which of one or more screens on which the presentation is to be viewed. As discussed herein in connection with the embodiment of the device 10, the tablet computer 200 may be loaded to operate slide presentation software, and an IntelliStrator add-in configuration toolbar may be installed to appear as a toolbar when the slide presentation program is used. For example, when the PowerPoint® slide presentation program is loaded for use on the computer 100, the add-in toolbar of the IntelliStrator may be configured to appear therewith.

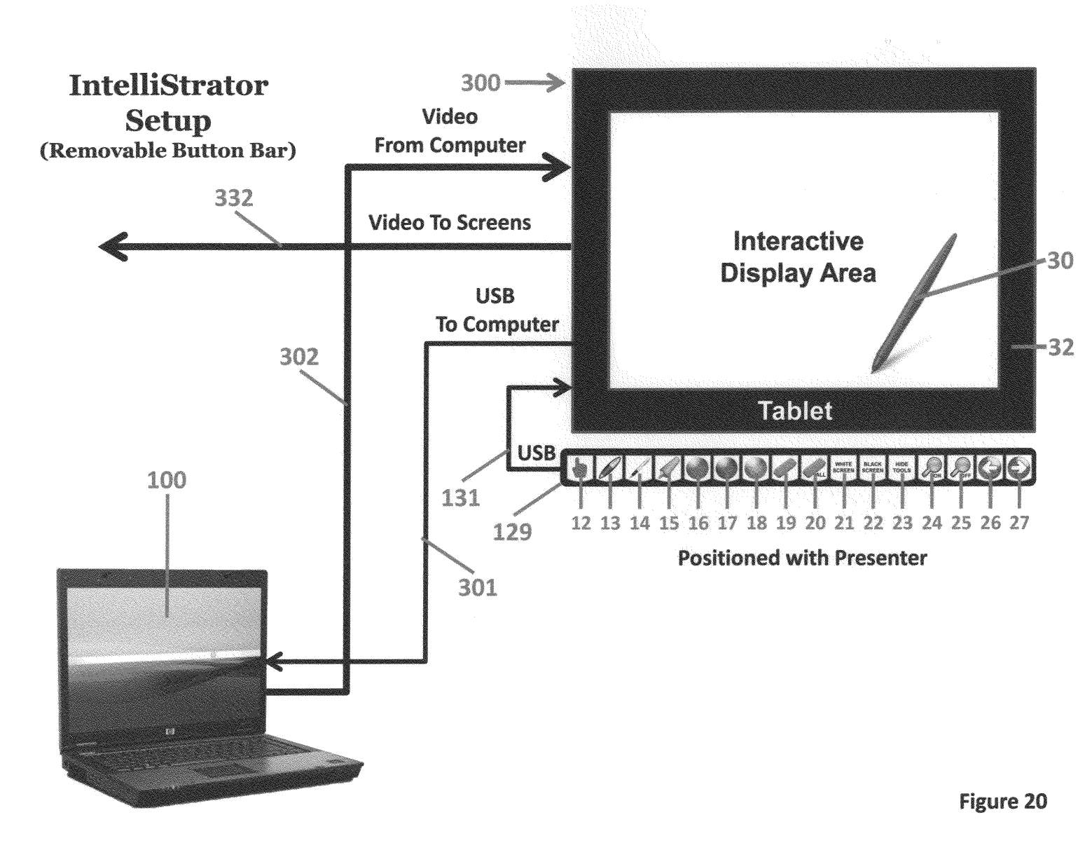

FIG. 20 illustrates an alternate embodiment of the device 210 wherein the IntelliStrator is configured with one or more input components. The input components are shown including a pen 30 and a button bar 129. The button bar 129 is linked with the tablet 300. The tablet 300 is shown having a connection 301 to the computer 100, which preferably may be a USB connection. An output connection 302 links the computer 100 with the tablet 300 and preferably comprises a video output from the computer, such as, for example, a VGA, HDMI, or other video link. The embodiment in FIG. 20 also is shown with an output 332 from the video of the tablet 300 to a video screen. The output 332 may be communicated through a video cable that may connect to one or more video screens for viewing of the presentation by an audience, or as discussed, alternately, the video output may be connected with a video switcher that may be used to control which of one or more screens on which the presentation is to be viewed.

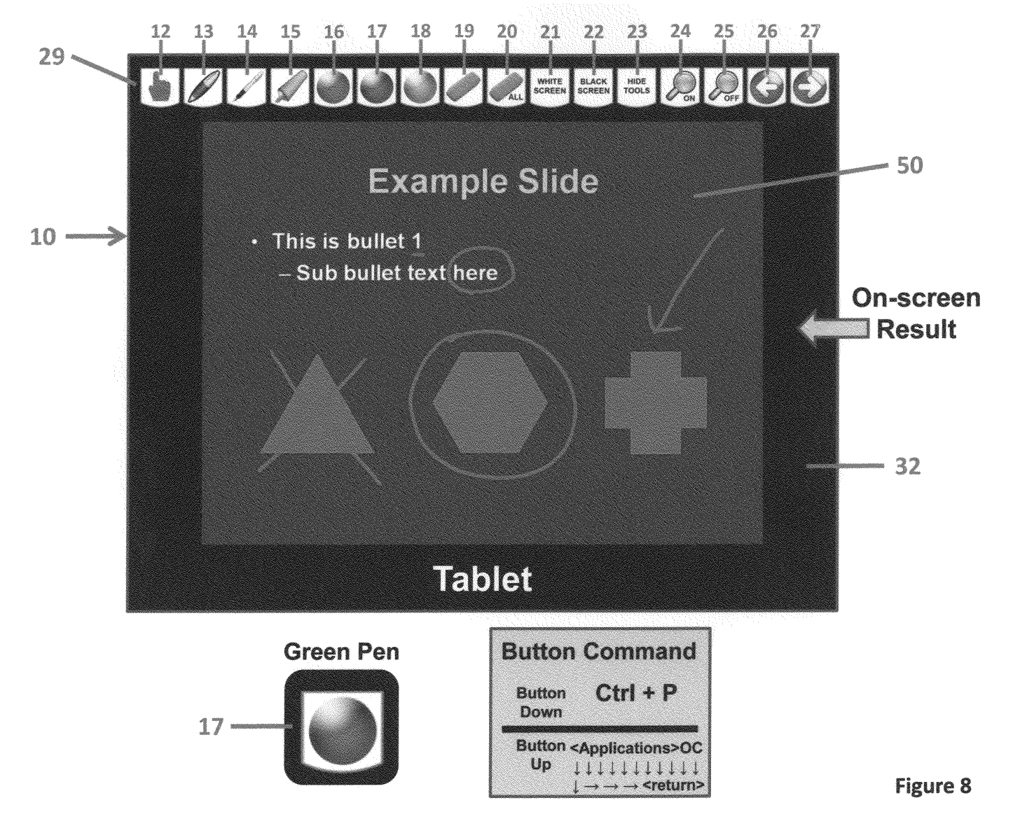

The system and device illustrated herein provide a simple yet powerful and intuitive way for presenters to interact with their presentations in multiple ways directly on an easy to see screen positioned in front of them using the icon based buttons as described herein. The following are examples of controls that may be used in conjunction with the device 10 and system described herein. I have referred to my device as the IntelliStrator (which is a brand name that will be used), and describe a preferred embodiment of the device 10 with the following interactive features.
Pointer: Gives the presenter the ability to point to any area of the screen and an easy to see pointer appears that will be seen on all screens connected after the IntelliStrator. The pointer will follow the presenter as they move around the screen and is configured in a preferred embodiment to disappear from the screen 5 seconds after the presenter stops pointing (FIG. 3). Alternately the pointer may be configured not to disappear from the screen (i.e., to remain on the screen display 11) unless the “hide tools” button 23 is selected.
Pen Thick: Gives the presenter the ability to draw and/or write on the screen with a thick easy to see line (FIG. 4).
Pen Thin: Gives the presenter the ability to draw and/or write on the screen with a thin line when a thick line may cover other objects or when more detail is required (FIG. 5).
Highlighter: Gives the presenter the ability to highlight text and/or objects (FIG. 6).
Red Pens: Gives the presenter the ability to use either pen providing a red line (FIG. 7).
Green Pens: Gives the presenter the ability to use either pen providing a green line (FIG. 8).
Yellow Pens: Gives the presenter the ability to use either pen providing a yellow line (FIG. 9).
Eraser: Gives the presenter the ability to erase individual markings (pen or highlighter) on the screen one at a time in any order (FIG. 10).
Eraser All: Gives the presenter the ability to erase all markings (pen or highlighter) on the screen (FIG. 11).
White Screen: Gives the presenter the ability to bring up a white screen and draw and/or write ideas/equations/drawings/etc. on the fly (FIG. 12).
Black Screen: Gives the presenter the ability to bring up a black screen and draw and/or write ideas/equations/drawings/etc. on the fly (FIG. 13).
Hide Tools: Gives the presenter the ability to hide all of the tools so they do not interfere with the slides readability (FIG. 14).
Magnify On: Gives the presenter the ability to magnify the area of the screen they are pointing to. According to a preferred embodiment, the magnification area will follow the presenter as they move the pen around the screen. According to a preferred configuration, the device is constructed so that the magnification area will stay in effect until Magnify Off is pressed (FIG. 15).
Magnify Off: Gives the presenter the ability to turn off the magnification and selects the pointer tool (FIG. 16).
Previous Slide: Gives the presenter the ability to go to the previous slide (FIG. 17)
Next Slide: Gives the presenter the ability to go to the next slide (FIG. 18)
   The IntelliStrator may be used by the presenter alone (FIG. 1) or may be configured so there is a second operator assisting the presenter (FIG. 19) with all of the same abilities (and more if required) as the presenter.

All annotations made on a PowerPoint® presentation can be saved with the presentation after it is presented.

The system, method and device facilitate the management of a presentation. A number of inputs may be accomplished using a single input button, or with the input pen or combinations of these input components. The input components are designed to provide immediate interactivity between a user who has a prepared slide presentation and the audience viewing it. The device 10, method and system permit interaction by the user as the presentation is being given (e.g., during the presentation) to make enhancements that may be contemporaneously appropriate or needed to enhance communication with an audience. The interactive display of the device 10 may be relatively compact in size, such as for example, a 15 inch display panel, so that it may be transported to the location where it is to be used. The device 10 has an interactive display, such as, for example an LCD touch screen, and may be linked with, or may be configured with components so that the output of the presentation that is shown on and manipulated on the interactive display, is communicated to a second display for viewing by an audience. For example, the presenter may use the device 10 at a podium or in front of a large room where attendees are present. The large room may have a monitor or other display on which the presentation, including the interactions of the user, may be displayed. According to one embodiment, the display is connected with a computer, and the slide presentation may be generated with the computer and presented on the interactive display. The input components of the device also preferably may be linked for communication with the computer to provide enhancements to the slide in real time contemporaneous with the user's presentation. The slides of the presentation may be a stored presentation already prepared by the presenter. The enhancements, such as writing, highlighting, and those features discussed herein, may be saved so that the slide show may be recorded with the user interactions made using the device.

The device 10 and system are designed to be utilized to facilitate interaction between a user or presenter and an audience. Some examples of the use of the device 10 and system are provided herein. A computer may be used to generate and operate a PowerPoint® slide presentation. The presentation may be run using the operating system of the computer. The device 10 preferably links with the computer (through a USB connection, or Bluetooth, for example)

According to preferred embodiments, the system and device include operable functions that may be used to facilitate interaction between the presenter, the presentation, the audience or combinations of them. The system and device include functions incorporated there into which, according to preferred embodiments, are native to Microsoft Windows® and PowerPoint®. The current configuration of the device 10 and system is tailored to be used in connection with PowerPoint®. Preferably, the features and functions discussed herein are described in connection with PowerPoint®. According to alternate embodiments, the system and device may be used with other programs but all of the functions may not apply as described herein (also there may be additional functions that may be apply for different programs that can be incorporated). Though the system and device are described herein with a Microsoft Windows® operating system, the system and device may be configured to operate for PowerPoint® presentations under other operating systems, such as, for example, Macintosh® operating systems, Linux®, and the like.

The system and device may include software that works in conjunction with PowerPoint® to provide enhanced interaction features. According to some embodiments, the software may be provided on a storage media, such as, for example, a disk, flash memory that may be installed on a computer or on the device 10, or may be directly embedded within the device (e.g., on a storage component, such as, for example a hard drive). The software instructions facilitate interaction by enabling a user or operator to manage and interact with a presentation, such as a PowerPoint® presentation, without the need to proceed through menu and submenu choices. Single button or pen implemented actuation may be utilized to provide immediate display of text, graphics or other indicia, during the presentation, and as the user or operator is interacting with those viewing the presentation.

An actuation mechanism may be provided and may be configured to appear as an add-in toolbar. Alternately, the actuation mechanism may be provided as a plug-in that may show a toolbar in PowerPoint®. The actuation mechanism may provide a button (e.g., such as a screen graphic) that the user may activate to prepare the open presentation for use with the device 10 and system. The user may utilize the functions of the add-in toolbar and make a selection to facilitate the interaction features that may be used in connection with the display area 11 to provide interaction with the presentation at the time the user is presenting it. For example, one of the toolbar functions may include a selection option that prepares the presentation so that the presentation may be used with the interactive input components (such as, for example, the buttons 12-27 and pen 30) of the IntelliStrator device 10. According to preferred embodiments, the selection mechanism may be implemented so that once the selection option is made from the toolbar and the presentation is prepared for use with the device 10, the selection option may remain as part of that presentation, so that when that presentation is saved and/or subsequently loaded for use, the presentation will be operable with the IntelliStrator device.

Software may be configured with instructions to operate the functions of the device and system. For example, a CD containing software may be installed the first time that the device 10 is used, and may thereafter provide a button so that the user need only activate the button (on a computer, for example) to prepare the presentation for use with the device 10. The device 10 may be operated through software that may be implemented as an add-in to presentation software, such as, for example, the PowerPoint® software. The add-in may appear as an overlay when the slide presentation program is in use, or may be docked on the toolbar menu of the slide presentation program. Once the IntelliStrator toolbars are loaded, they may be accessed when the slide presentation program (e.g., PowerPoint®) is opened. The IntelliStrator toolbar menu may include an activation button (not shown) that, when selected, configures the presentation to work with the input components of the device 10, such as, for example, the button bar buttons and pen 30, so that they may be used. According to preferred embodiments, the toolbar preferably is configured for an editing feature, such as, for example, the edit mode of the PowerPoint® software. Once the toolbar is implemented to work in conjunction with a slide presentation program such as, for example, PowerPoint®, (e.g., installed as an add-in), the toolbar will continue to load, and the toolbar preparation selection option preferably is available for current and new slide presentations. Though reference is made to a CD, other media distribution methods may be used to install the software, such as, for example, downloading, supplying flash memory, and the like.

According to preferred embodiments, the device 10 may be used to facilitate interaction and management of a presentation. One example of benefits and ease of use for the presenter with the device 10 (which is referred to as IntelliStrator) may be that the ItelliStrator or device 10 gives the presenter the ability to interact with his or her presentation. An example of this would be a presenter giving a presentation to a large audience who are watching multiple screens. In a typical setup the presenter would have a laser pointer and could choose one screen to point at, the portion of the audience watching that screen would see what was being pointed at but the rest of the audience will most likely miss the interaction because they are focused on another screen. With the IntelliStrator device 10 the presenter may point to the slide on the IntelliStrator device display screen 11 in front of him or her and a pointer is displayed on all of the screens so no matter which screen a member of the audience is watching that audience member will see the interaction. Another benefit is that the presenting user does not have to turn away from the audience to point at a screen located behind the user, which one would do with the laser pointer.

That is one very simple use of the IntelliStrator device 10 but is something that has been a need in the meetings industry for years. Where the IntelliStrator device 10 really becomes powerful is when the presenter starts using the other tools and features of the device 10 to interact with the user's presentation. For example the user or presenter could have a slide that features a table filled with different numbers. With the present device 10, instead of just pointing to a number within the table, the user may select the pen tool (from the selection buttons) and circle the number. Another exemplary feature of the device 10 is that the user or presenter can also use different colors to circle different types of data and refer to the data by color so it becomes very easy for the audience to follow through complex data that the user is presenting. As the user is annotating the presentation, the user may make a mistake. The present device 10 and system permit the user, with the press of a button (e.g., an eraser button), to selectively erase the mistake, and then reselect the tool the user was previously using and continue the annotations. Another example of features of the device may be in connection with a slide with text, where, the user or presenter, with the press of a button, may start highlighting words to make them stand out as the user or presenter speaks about the highlighted matter. This may be accomplished in combination with underlining, circling, etc. Another example would be a situation where the presenter has filled the slide with a lot of data that is very small in order to make it fit on a single slide. Instead of apologizing to the audience because the slide data cannot be read, the information may be enhanced for visibility during the presentation by pressing the magnification button to enlarge the area the user is talking about. The device 10 and system permit the user to move the magnification area around the slide as the user speaks about different information contained within the slide. These are some examples of what the IntelliStrator device 10 and system may do.

Using the tools provided by the IntelliStrator device 10 and system permits a presenter to stay focused on the audience, and thereby provides a powerful interactive presentation tool. Providing all of the functionality in a simple intuitive interface that is designed to take no thought away from the presentation the presenter is giving makes the device 10 and system a powerful asset for the presenter. The method, system and device, according to preferred embodiments, provide interactivity with the slide presentation so that inputs from one or more of the interactive components of the device may interact with the information on the slide so that the slide may be modified or enhanced with the interaction indicia in a manner that may be saved. The slide presentation may, for example, be manipulated using the interactive input components described herein, and the manipulated slide may be saved in the manipulated form. According to preferred embodiments, the slide with the interactive indicia may be saved for future reference or presentations so that the user's interactive input may be included. The saved slide, for example, may be edited, and the enhancements made with the IntelliStrator device during a presentation may be edited as part of a saved slide presentation. According to preferred embodiments, the method, system and device provide a user with the ability to utilize interactive features during a presentation, save the presentation with the enhancements made using the interactive features, and even further manipulate the enhancements that have been saved as part of a saved presentation. For example, considering the slide 50 illustrated in FIG. 9, interactive indicia is shown with yellow pen lining, for example, the yellow line encircling the green triangle appearing on the slide 50. The user may use the interactive buttons 12-27 of the button bar 29, the pen 30 or a combination thereof to make enhancements to the slide 50, such as encircling the triangle with a yellow line. FIG. 10 illustrates that the interactive buttons 12-27 of the button bar 29 include a feature of an eraser that may be implemented using the eraser button 19. The eraser feature enables a user to interact with the slide presentation and manipulate the indicia that the user draws on the slide during the presentation, such as the yellow circle shown in FIG. 10. According to preferred embodiments, the slide presentation may be saved with the interactive indicia that a user may make during a presentation. According to preferred embodiments, the user may manipulate the slide and the enhancements during the presentation, and subsequent to a presentation. This enables a user to store and view the interactive enhancements, as well as add to them or remove them, if desired. Preferably, the device is configured to recognize, capture and store interactive enhancements that appear on the display screen 11. This is done in conjunction with the PowerPoint® software and is contained in the presentation and available when that presentation is opened on any system.

For example, a saved slide presentation may be further enhanced subsequent to being stored, so that the user may even edit the enhancements that the user made. The user may selectively edit one or more enhancements made to a saved slide. For example, if the user saves a presentation, and a slide of that presentation, such as for example, the slide 50 as shown in FIG. 9, has an “x” through one shape, an arrow pointing to another shape, and a circle around a third shape, that user may edit the slide 50. For example, the user may choose to remove all of the enhancements, or the user may choose to remove one or more of the enhancements, such as removing the circle (or a part of the circle) while leaving the arrow and “x”. The present method, system and device provide flexibility for subsequent editing of the interactive indicia that a user places on a slide during a presentation. According to a preferred embodiment, the user may use the IntelliStrator device and make enhancements during a slide presentation, save the presentation with the enhancements and perform subsequent editing of the enhancements.

Alternate embodiments include providing one or more input controllers, so that multiple users may operate the device and manage or co-manage a presentation. As used herein, therefore, the references to the user performing certain functions may, according to some embodiments, apply to an operator who is managing the presentation (or to both where an operator and user are involved in the presentation). In addition, though a pen is shown and described, a touch screen may be operated using one's finger.

These and other advantages are provided by my invention. While the invention has been described with reference to specific embodiments, the description is illustrative and is not to be construed as limiting the scope of the invention. Various modifications and changes may occur to those skilled in the art without departing from the spirit and scope of the invention described herein and as defined by the appended claims.

What is claimed is:

1. A device for interacting with and managing a presentation comprising:
a display screen;
input components for managing images on the display screen;
wherein the input components comprise a pen and a plurality of interactive buttons linked with the features of the presentation software to enhance and facilitate presentation of information on the display screen.

2. The device of claim 1, wherein the display screen comprises a display area, and wherein the interactive buttons are provided outside of the display area.

3. The device of claim 2, wherein the device includes at least one button linked with software programmed to operate one or more interactive effects for a slide presentation based on a first group of multiple selections corresponding to the at least one button.

4. The device of claim 3, wherein the at least one button is linked with software programmed to operate one or more interactive effects for a slide presentation based on a second group of multiple selections corresponding to the at least one button.

5. The device of claim 4, wherein the at least one button is configured to activate an interactive effect based on said first group of multiple selections when the button is depressed and wherein the at least one button is configured to activate an interactive effect based on said second group of multiple selections when the button is released.

6. The device of claim 1, wherein the display screen is linked to provide an output to a second display for viewing.

7. The device of claim 1, wherein the display screen is configured as a panel with a plurality of buttons.

8. The device of claim 7, wherein the display comprises a touch screen display.

9. The device of claim 8, further including an input component configured to cooperate with said touch screen display to provide inputs at the location of the touch screen at which the input component is positioned.

10. The device of claim 7, wherein the buttons include a light source.

11. The device of claim 10, wherein the buttons include LED as a light source.

12. The device of claim 10, wherein the buttons include a screen that may be programmed with an image.

13. The device of claim 10, wherein the light source comprises an OLED.

14. The device of claim 1, including software configured to provide instructions to a processor that is linked to an output that is communicated to the interactive display screen to generate images on said display screen.

15. The device of claim 14, wherein the images communicated for display on said interactive display screen include at least one or more slides of a slide presentation.

16. The device of claim 15, wherein the images communicated for display on said interactive display include images based on user inputs during the time that the slide appears on the display.

17. The device of claim 16, wherein said user inputs are implemented through one or more of interactive buttons provided on said device in a location outside of the interactive display area and an input component that is configured to operate within the interactive display area.

18. The device of claim 1, including an input component that comprises a pointing device that corresponds with the location of a pointing icon on said interactive display area.

19. The device of claim 18, wherein said pointing device is activated by at least one interactive button provided on said device.

20. The device of claim 19, wherein said pointing device is deactivated by at least one or more additional interactive buttons provided on said device.

21. The device of claim 18, wherein said pointing device has at least one or more interactive attributes which may be selected by a user from one or more interactive buttons provided on said device.

22. The device of claim 21, wherein said attributes comprise one or more characteristics selected from the group consisting of line thickness and line color.

23. The device of claim 1, wherein said display screen comprises an interactive display area, the device further comprising a magnification feature for selectively magnifying an area of a slide image that is displayed on said interactive display area of said device, said magnification feature being activated with an interactive button provided on said device.

24. The device of claim 23, wherein an input component is configured to operate in conjunction with said magnification feature to provide selectability of a zone of magnification through the movement of said input component on said interactive display area.

25. The device of claim 1, wherein a plurality of interactive input buttons are configured to activate features that may be implemented by a user making a presentation to enhance one or more slides with additional indicia on the slide, the device being configured to display a slide from said presentation and said additional enhancement indicia on the interactive display screen and on at least one other second video display screen.

26. The device of claim 25, wherein the device is configured to manage the additional indicia provided on the slide by a user using said input components, the device being configured to generate said indicia to appear as an enhancement to said slide that may be saved along with said slide for further manipulation.

27. A system for interacting with and managing a presentation, comprising the device of claim 1, a processor linked with the device for processing instructions from software for a slide presentation, and instructions from inputs received from the device.

28. The system of claim 27, further including a secondary controller having input components for managing the presentation.

29. The system of claim 28, wherein the secondary controller and device both may be used to manage the presentation.

30. A method for managing and interacting with a presentation, comprising:
a) providing an interactive display;
b) providing a processor linked to operate with said interactive display;
c) providing a storage device for storing data used to generate the presentation;
d) providing input components associated with the interactive display;
e) processing with said processor instructions based on signals provided from the actuation of said input components to cause to be displayed information on said interactive display;
f) wherein the information displayed on said interactive display includes slides from a presentation and enhancements to said slides based on the inputs from said input components; and
g) manipulating the information that is displayed from said input components to enhance the information provided by the slides of the presentation.

31. The method of claim 30, wherein the input components comprise a plurality of buttons that are configured to provide a first response when depressed that provides a first interactive effect that is configured to effect an image displayed to appear on said interactive display screen and to provide a second response when released to provide a second interactive effect that is configured to effect an image appearing on said interactive display screen.

32. The method of claim 30, wherein at least one or more secondary displays are connected for synchronized viewing of said slide presentation and enhanced information of said slide presentation based on the images appearing on said interactive display.

33. The method of claim 32, wherein at least one input component includes a pointing device and wherein said pointing device is synchronized with an icon so that the movement of said pointing device across said interactive display screen displays the movement of said pointing device across said one or more secondary displays connected for synchronized viewing.

34. The method of claim 33, wherein selecting an input component is not revealed on the interactive display until the activation of the component selection is activated.

35. The method of claim 34, wherein the slide image displayed on the display screen does not reveal which buttons have been selected until the feature represented by the button is operable on said interactive display screen.

36. The method of claim 30, wherein said button selections remain outside said screen display area, wherein at least one or more secondary displays are provided for audience viewing, and wherein said interactive display screen displays the same image as said one or more secondary displays provided for audience viewing, and displays the results of the interactive input components selected and utilized by the user to manipulate the effects of a slide image.

38. A device for interacting with and managing a presentation generated with a presentation software program, the device comprising:
input components for managing images generated for display and displayed on a display screen;
wherein the input components comprise a plurality of interactive buttons configured to operate in conjunction with a presentation software program to enhance and facilitate presentation of information on the display screen and provide through said user selections of said plurality of interactive buttons interactive user inputs which are provided to facilitate user input being displayed with said presentation; and
wherein the input components are actuated through a toolbar provided for use with the presentation software program and being configured to actuate the interactive buttons.

39. The device of claim 38, wherein said interactive buttons are linked to at least one computing device operating the presentation software, and wherein said output of said presentation software comprises a first image, and wherein said interactive user inputs are output to be displayed on said first image, the device being configured with software so that user interactive inputs may be saved as part of the presentation, and wherein said saved user interactive inputs may be saved with said presentation so that a presentation that includes slides as part of the presentation may further include the user interactive inputs made using the interactive buttons.
